(19) United States
(12) Patent Application Publication
(10) Pub. No.: US 2021/0309878 A1
(43) Pub. Date: Oct. 7, 2021

(54) FLUID SETS

(71) Applicant: Hewlett-Packard Development Company, L.P., Spring, TX (US)

(72) Inventors: Dennis Z. GUO, San Diego, CA (US); Jie ZHENG, San Diego, CA (US)

(73) Assignee: Hewlett-Packard Development Company, L.P., Spring, TX (US)

(21) Appl. No.: 17/267,070

(22) PCT Filed: Feb. 1, 2019
(86) PCT No.: PCT/US2019/016226

§ 371 Date: Feb. 9, 2021

Related U.S. Application Data
(63) Continuation of application No. PCT/US2018/065979, filed on Dec. 17, 2018.
Application No. PCT/US2018/065979 is a continuation of application No. PCT/US2019/012862, filed on Jan. 9, 2019.

(51) Int. Cl. C09D 11/54; C09D 11/324; C09D 11/102; C08L 75/04; C08L 79/02; C08L 79/04; B41J 11/00; B41J 2/21; B41M 5/00; D06P 1/44; D06P 1/52

(52) U.S. Cl. CPC C09D 11/54; C09D 11/324; C09D 11/102; C08L 75/04; C08L 79/02; D06P 1/5285; B41J 11/002; B41J 2/21; B41M 5/0017; D06P 1/445; C08L 79/04

(57) ABSTRACT

A fluid set includes an ink composition including an aqueous ink vehicle, pigment, and from 2 wt % to 15 wt % polyurethane binder. The fluid set also includes a fixer fluid composition including an aqueous fixer vehicle, and from 0.5 wt % to 12 wt % cationic polymer comprising an azetidinium-containing polyamine polymer and a second quaternary amine-containing polymer.

### BACKGROUND

Inkjet printing has become a popular way of recording images on various media. Some of the reasons include low printer noise, variable content recording, capability of high speed recording, and multi-color recording. This can be obtained at a relatively low cost to consumers. As the popularity of inkjet printing increases, the types of use also increase providing demand for new ink compositions. In one example, textile printing can have various applications including the creation of signs, banners, artwork, apparel, wall coverings, window coverings, upholstery, pillows, blankets, flags, tote bags, clothing, etc.

### BRIEF DESCRIPTION OF THE DRAWINGS

FIG. 1 schematically represents an example fluid set, including an ink composition and a fixer fluid composition, in accordance with the present disclosure;

FIG. 2 schematically depicts an example textile printing system that includes an ink composition, a fixer fluid composition, and a print media substrate, in accordance with the present disclosure; and

FIG. 3 depicts an example method of printing in accordance with the present disclosure.

### DETAILED DESCRIPTION

In accordance with the present disclosure, a fluid set includes an ink composition and a fixer fluid composition. The ink composition includes an aqueous ink vehicle, pigment, and from 2 wt % to 15 wt % polyurethane binder. The fixer fluid composition includes an aqueous fixer vehicle, and from 0.5 wt % to 12 wt % cationic polymers comprising an azetidinium-containing polyamine polymer and a second quaternary amine-containing polymer. In one example, the pigment can include a black pigment, a cyan pigment, a magenta pigment, a yellow pigment, or a white pigment. In another example, the azetidinium-containing polyamine polymer includes from 2 to 12 carbon atoms between individual amine groups. The azetidinium-containing polyamine polymer can have a molar ratio of crosslinked or uncrosslinked azetidinium groups to amine groups from 0.1:1 to 10:1. On the other hand, the second quaternary amine-containing polymer can include a quaternary polydiallyldimethylammonium polymer, a quaternary ionene-containing polymer, a quaternary epichlorohydrin amine polymer, a quaternary alkoxylated quaternary polyamine, a quaternary N,N-dimethylaminoethyl methacrylate, or a combination thereof. The azetidinium-containing polyamine polymer to second quaternary amine-containing polymer weight ratio can be from 1:9 to 9:1. The fixer fluid composition can have a pH from 2 to 6. Furthermore, the fixer fluid composition can have a viscosity from 1.5 cP to 12 cP at 25° C.

In another example, a printing system includes a fabric substrate, an ink composition, and a fixer fluid composition. The ink composition includes an aqueous ink vehicle, pigment, and from 2 wt % to 15 wt % polyurethane binder. The fixer fluid composition includes an aqueous fixer vehicle, and from 0.5 wt % to 12 wt % of cationic polymer comprising an azetidinium-containing polyamine and a second quaternary amine-containing polymer. In one example, the fabric substrate can be selected from cotton, polyester, nylon, silk, or a blend thereof. In another example, the azetidinium-containing polyamine polymer can have a ratio of crosslinked or uncrosslinked azetidinium groups to amine groups from 0.1:1 to 10:1.

In another example, a method of printing includes jetting a fixer fluid composition onto a fabric substrate, wherein the fixer fluid composition includes an aqueous fixer vehicle and from 0.5 wt % to 12 wt % of cationic polymers comprising an azetidinium-containing polyamine and a second quaternary amine-containing polymer. The method further includes jetting an ink composition onto the fabric substrate in contact with the fixer fluid composition, wherein the ink composition includes an aqueous ink vehicle, pigment, and from 2 wt % to 15 wt % polyurethane binder. In one example, the cationic polymer and the polyurethane can be jetted onto the fabric substrate in contact at a weight ratio from 0.01:1 to 1:1, wherein the cationic polymer content is based on a total content of the azetidinium-containing polyamine and a second quaternary amine-containing polymer. The method can further include heating the fabric substrate having the fixer fluid composition and the ink composition jetted thereon to a temperature from 80° C. to 200° C. for a period from 5 seconds to 10 minutes. The azetidinium-containing polyamine can have a ratio of crosslinked or uncrosslinked azetidinium groups to amine groups from 0.1:1 to 10:1.

In addition to the examples described above, the fluid sets, printing systems, and methods of printing will be described in greater detail below. It is also noted that when discussing the fluid sets, printing systems and method of printing described herein, these relative discussions can be considered applicable to the other examples, whether or not they are explicitly discussed in the context of that example. Thus, for example, in discussing a fixer fluid composition related to a fluid set, such disclosure is also relevant to and directly supported in the context of the printing system and the methods of printing described herein, and vice versa.

Turning now to FIG. 1, an ink composition 100 can include an ink vehicle 102 (which can include water and organic co-solvent, for example) and pigment 104 (or pigment particles or solids) dispersed therein. A polyurethane polymer 106 can also be present. In this FIG., the relative sizes of the pigment and the polyurethane polymer are not drawn to scale. Furthermore, the pigment can further include a dispersing agent or dispersing polymer associated with a surface thereof, e.g., covalently attached as a part of a self-dispersed pigment, or ionically attracted to or adsorbed onto the pigment surface, etc.

The pigment 104 can be any of a number of pigment colorant of any of a number of primary or secondary colors, or can be black or white, for example. More specifically, if a color, the pigment colorant may include cyan, magenta, yellow, red, blue, violet, orange, green, etc. In one example, the ink composition 100 can be a black ink with a carbon black pigment. In another example, the ink composition can be a cyan or green ink with a copper phthalocyanine pigment, e.g., Pigment Blue 15:0, Pigment Blue 15:1, Pigment Blue 15:3, Pigment Blue 15:4, Pigment Green 7, Pigment Green 36, etc. In another example, the ink composition can be a magenta ink with a quinacridone pigment or a co-crystal of quinacridone pigments. Example quinacridone pigments that can be utilized can include PR122, PR192, PR202, PR206, PR207, PR209, P048, P049, PV19, PV42, or the like. These pigments tend to be magenta, red, orange, violet, or other similar colors. In one example, the quinacridone pigment can be PR122, PR202, PV19, or a combination thereof. In another example, the ink composition can be a yellow ink with an azo pigment, e.g., Pigment Yellow 74 and Pigment Yellow 155. In one example, the pigment can include aromatic moieties. In yet another example, the ink composition can be a white ink with a white pigment, e.g. titanium dioxide, talc, zinc oxide, zinc sulfide, lithopone, etc.

With respect to the dispersing agent or dispersing polymer mentioned previously, in some examples, the pigment 104 can be dispersed by a polymer dispersant, such as a styrene (meth)acrylate dispersant, or another dispersant suitable for keeping the pigment suspended in the ink vehicle 102. For example, the dispersant can be any dispersing (meth)acrylate polymer, or other type of polymer, such as a styrene maleic acid copolymer. In one specific example, the (meth)acrylate polymer can be a styrene-acrylic type dispersant polymer, as it can promote π-stacking between the aromatic ring of the dispersant and various types of pigments, such as copper phthalocyanine pigments, for example. Examples of commercially available styrene-acrylic dispersants can include Joncryl® 671, Joncryl® 71, Joncryl® 96, Joncryl® 680, Joncryl® 683, Joncryl® 678, Joncryl® 690, Joncryl® 296, Joncryl® 671, Joncryl® 696 or Joncryl® ECO 675 (all available from BASF Corp., Germany).

The term “(meth)acrylate” or “(meth)acrylic acid” or the like refers to monomers, copolymerized monomers, etc., that can either be acrylate or methacrylate (or a combination of both), or acrylic acid or methacrylic acid (or a combination of both). This can be the case for either dispersant polymer for pigment dispersion or for dispersed polymer binder that may include co-polymerized acrylate and/or methacrylate monomers. Also, in some examples, the terms “(meth)acrylate” and “(meth)acrylic acid” can be used interchangeably, as acrylates and methacrylates described herein include salts of acrylic acid and methacrylic acid, respectively. Thus, mention of one compound over another can be a function of pH. Furthermore, even if the monomer used to form the polymer was in the form of a (meth)acrylic acid during preparation, pH modifications during preparation or subsequently when added to an ink composition can impact the nature of the moiety as well (acid form vs. salt form). Thus, a monomer or a moiety of a polymer described as (meth)acrylic acid or as (meth)acrylate should not be read so rigidly as to not consider relative pH levels, and other general organic chemistry concepts.

In further detail, the ink composition 100 can also include a polyurethane binder 106. A variety of polyurethane binders can be used. In one example, the polyurethane binder is a polyester-polyurethane binder. In some further examples, the polyurethane binder can be a sulfonated polyester-polyurethane. In one example, the sulfonated polyester-polyurethane binder can be anionic. In further detail, the sulfonated polyester-polyurethane binder can also be aliphatic including saturated carbon chains therein as part of the polymer backbone or side-chain thereof, e.g., C2 to C10, C3 to C8, or C3 to C6 alkyl. These polyester-polyurethane binders can be described as “alkyl” or “aliphatic” because these carbon chains are saturated and because they are devoid of aromatic moieties. An example anionic aliphatic polyester-polyurethane binder that can be used is Impranil® DLN-SD (Mw 133,000 Mw; Acid Number 5.2; Tg −47° C.; Melting Point 175-200° C.) from Covestro (Germany). Example components used to prepare the Impranil® DLN-SD or other similar anionic aliphatic polyester-polyurethane binders can include pentyl glycols, e.g., neopentyl glycol; C4-C10 alkyldiol, e.g., hexane-1,6-diol; C4 to C10 alkyl dicarboxylic acids, e.g., adipic acid; C4 to C10 alkyl diisocyanates, e.g., hexamethylene diisocyanate (HDI); diamine sulfonic acids, e.g., 2-[(2-aminoethyl)amino]-ethanesulfonic acid; etc. Alternatively, the polyester-polyurethane binder can be aromatic (or include an aromatic moiety) along with aliphatic chains. An example of an aromatic polyester-polyurethane binder that can be used is Dispercoll® U42 (CAS #83111-01-7). Example components used to prepare the Dispercoll® U42 or other similar aromatic polyester-polyurethane binders can include aromatic dicarboxylic acids, e.g., phthalic acid; C4 to C10 alkyl dialcohols, e.g., hexane-1,6-diol; C4 to C10 alkyl diisocyanates, e.g., hexamethylene diisocyanate (HDI); diamine sulfonic acids, e.g., 2-[(2-aminoethyl)amino]-ethanesulfonic acid; etc. Other types of polyester-polyurethanes can also be used, including Impranil® DL 1380, which can be somewhat more difficult to jet from thermal inkjet printheads compared to Impranil® DLN-SD and Dispercoll® U42, but still can be acceptably jetted in some examples, and can also provide acceptable washfastness results on a variety of fabric types. Conversely, other types of polyurethanes (other than the polyester-type polyurethanes) do not tend to perform as well when jetting from thermal inkjet printheads and/or do not perform as well on fabric substrates, e.g., some jet acceptably but do not provide good washfastness, others provide good washfastness but are thermally jetted poorly, and others perform poorly in both categories. In still further detail, the pigmented ink compositions with polyester polyurethane binder can provide acceptable to good washfastness durability on a variety of substrates, making this a versatile ink composition for fabric printing, e.g., cotton, polyester, cotton/polyester blends, nylon, etc.

The polyurethane binder can typically be present in the ink composition in an amount from 2 wt % to 15 wt %. In other examples, the polyurethane binder can be present in the ink composition in an amount from 3 wt % to 11 wt %. In yet other examples, the polyurethane binder can be present in the ink composition in an amount from 4 wt % to 10 wt %. In still other examples, the polyurethane binder can be present in the ink composition in an amount from 5 wt % to 9 wt %.

Returning now to FIG. 1, the ink composition 100 of the present disclosure can be formulated to include an ink vehicle 102, which can include the water content, e.g., 60 wt % to 90 wt % or from 75 wt % to 85 wt %, as well as organic co-solvent, e.g., from 4 wt % to 30 wt %, from 6 wt % to 20 wt %, or from 8 wt % to 15 wt %. Other liquid vehicle components can also be included, such as surfactant, antibacterial agent, other colorant, etc. However, as part of the ink composition, pigment, polymer dispersant, and the polyurethane polymer can be included or carried by the ink vehicle components.

In further detail regarding the ink vehicle 102, co-solvent(s) can be present and can include any co-solvent or combination of co-solvents that is compatible with the pigment, dispersant, polyurethane binder, etc. Examples of suitable classes of co-solvents include polar solvents, such as alcohols, amides, esters, ketones, lactones, and ethers. In additional detail, solvents that can be used can include aliphatic alcohols, aromatic alcohols, diols, glycol ethers, polyglycol ethers, caprolactams, formamides, acetamides, and long chain alcohols. Examples of such compounds include primary aliphatic alcohols, secondary aliphatic alcohols, 1,2-alcohols, 1,3-alcohols, 1,5-alcohols, ethylene glycol alkyl ethers, propylene glycol alkyl ethers, higher homologs (C₆-C₁₂) of polyethylene glycol alkyl ethers, N-alkyl caprolactams, unsubstituted caprolactams, both substituted and unsubstituted formamides, both substituted and unsubstituted acetamides, and the like. More specific examples of organic solvents can include 2-pyrrolidone, 2-ethyl-2-(hydroxymethyl)-1,3-propane diol (EPHD), glycerol, dimethyl sulfoxide, sulfolane, glycol ethers, alkyldiols such as 1,2-hexanediol, and/or ethoxylated glycerols such as LEG-1, etc.

The ink vehicle can also include surfactant. In general, the surfactant can be water soluble and may include alkyl polyethylene oxides, alkyl phenyl polyethylene oxides, polyethylene oxide (PEO) block copolymers, acetylenic PEO, PEO esters, PEO amines, PEO amides, dimethicone copolyols, ethoxylated surfactants, alcohol ethoxylated surfactants, fluorosurfactants, and mixtures thereof. In some examples, the surfactant can include a nonionic surfactant, such as a Surfynol® surfactant, e.g., Surfynol® 440 (from Evonik, Germany), or a Tergitol™ surfactant, e.g., Tergitol™ TMN-6 (from Dow Chemical, USA). In another example, the surfactant can include an anionic surfactant, such as a phosphate ester of a C10 to C20 alcohol or a polyethylene glycol (3) oleyl mono/di phosphate, e.g., Crodafos® N3A (from Croda International PLC, United Kingdom). The surfactant or combinations of surfactants, if present, can be included in the ink composition at from 0.01 wt % to 5 wt % and, in some examples, can be present at from 0.05 wt % to 3 wt % of the ink compositions.

Consistent with the formulations of the present disclosure, various other additives may be included to provide desired properties of the ink composition for specific applications. Examples of these additives are those added to inhibit the growth of harmful microorganisms. These additives may be biocides, fungicides, and other microbial agents, which are routinely used in ink formulations. Examples of suitable microbial agents include, but are not limited to, Acticide®, e.g., Acticide® B20 (Thor Specialties Inc.), Nuosept™ (Nudex, Inc.), Ucarcide™ (Union carbide Corp.), Vancide® (R.T. Vanderbilt Co.), Proxel™ (ICI America), and combinations thereof. Sequestering agents such as EDTA (ethylene diamine tetra acetic acid) may be included to eliminate the deleterious effects of heavy metal impurities, and buffer solutions may be used to control the pH of the ink. Viscosity modifiers and buffers may also be present, as well as other additives to modify properties of the ink as desired.

As also shown in FIG. 1, a fixer fluid composition 110 is also shown, which can include cationic polymer including an azetidinium-containing polyamine 114 as well as a second quaternary amine-containing polymer 116 in a fixer vehicle 112. Notably, the ink vehicle in the ink composition and the fixer vehicle in the fixer fluid composition may or may not include the same liquid vehicle formulation, but in one example they are not the same. Regardless, whether the ink vehicle and the fixer vehicle are the same, they can in some examples include common ingredients, such as water, for example or other common organic co-solvents. Whether the same or different, both can also include an organic co-solvent. Thus, the discussion of the liquid vehicle described herein related to the ink composition is also relevant to the fixer vehicle of the fixer fluid composition, and the same types of liquid vehicle components can be independently selected for use therein.

In some specific examples, the fixer vehicle can include water and an organic co-solvent. Typically, water can be present in the fixer fluid composition in an amount from 65 wt % to 96 wt %. In other examples, water can be present in the fixer fluid composition in an amount from 70 wt % to 90 wt %. In still other examples, water can be present in the fixer fluid composition in an amount from 75 wt % to 85 wt %. Organic co-solvent can typically be present in the fixer fluid composition in an amount from 1.5 wt % to 34.5 wt %. In some examples, organic co-solvent can be present in the fixer fluid composition in an amount from 4 wt % to 20 wt %. In another examples, organic co-solvent can be present in the fixer fluid composition in an amount from 6 wt % to 16 wt %, or from 8 wt % to 14 wt %.

With specific reference to the azetidinium-containing polyamine 114 that is present in the fixer fluid composition 110, FIG. 1 presents a representative simplified schematic formula for illustrative purposes, and should not be considered limiting. The azetidinium-containing polyamine selected for use can include any of a number of cationic polyamines with a plurality of azetidinium groups. In an uncrosslinked state, as shown in Formula I below, an azetidinium group generally has a structure as follows:

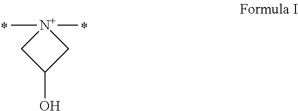

As shown in Formula I, this structure is not intended to show repeating units, but rather merely a polymer that includes the azetidinium groups shown in Formula I, including azetidinium-containing polyamines having a weight average molecular weight from 1,000 Mw to 2,000,000 Mw, from 2,000 Mw to 1,000,000 Mw, from 5,000 Mw to 200,000 Mw, from 5,000 Mw to 100,000 Mw, or from 20,000 to 1,000,000 Mw, for example. The asterisks (*) in Formula I represent portions of the various organic groups, polymeric portions, functional moieties, etc., for example.

In some examples, the cationic polymer including the azetidinium-containing polyamine can be derived from the reaction of a polyalkylene polyamine (e.g. ethylenediamine, bishexamethylenetriamine, and hexamethylenediamine, for example) with an epihalohydrin (e.g. epichlorohydrin, for example) (referred to as PAmE resins). In some specific examples, the cationic polymer including an azetidinium-containing polyamine can include the structure:

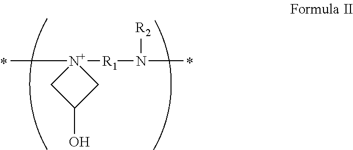

where R₁ can be a substituted or unsubstituted C₂-C₁₂ linear alkyl group and R₂ is H or CH₃. In some additional examples, R₁ can be a C₂-C₁₀, C₂-C₈, or C₂-C₆ linear alkyl group. More generally, there can typically be from 2 to 12 carbon atoms between amine groups (including azetidinium groups) in the azetidinium-containing polyamine. In other examples, there can be from 2 to 10, from 2 to 8, or from 2 to 6 carbon atoms between amine groups in the azetidinium-containing polyamine. In some examples, where R₁ is a C₃-C₁₂ (or C₃-C₁₀, C₃-C₈, C₃-C₆, etc.) linear alkyl group, a carbon atom along the alkyl chain can be a carbonyl carbon, with the proviso that the carbonyl carbon does not form part of an amide group (i.e. R₁ does not include or form part of an amide group). In some additional examples, a carbon atom of R₁ can include a pendent hydroxyl group. The number of units as shown in Formula II can be any number of units that results in an azetidinium-containing polyamine having a weight average molecular weight from 1,000 Mw to 2,000,000 Mw, from 2,000 Mw to 1,000,000 Mw, from 5,000 Mw to 200,000 Mw, from 5,000 Mw to 100,000 Mw, or from 20,000 to 1,000,000 Mw, for example. These units can be repeating along the polymer, along portions of the polymer, and/or can have other moieties between individual units shown in Formula II. Thus, the asterisks (*) in Formula II represent portions of polymer that are not shown, but could include various organic groups, polymeric portions, functional moieties, etc., for example.

As can be seen in Formula II, the azetidinium-containing polyamine can include a quaternary amine (e.g. azetidinium group) and a non-quaternary amine (i.e. a primary amine, a secondary amine, a tertiary amine, or a combination thereof). In some specific examples, the azetidinium-containing polyamine can include a quaternary amine and a tertiary amine. In some additional examples, the azetidinium-containing polyamine can include a quaternary amine and a secondary amine. In some further examples, the azetidinium-containing polyamine can include a quaternary amine and a primary amine. It is noted that, in some examples, some of the azetidinium groups of the azetidinium-containing polyamine can be crosslinked to a second functional group along the azetidinium-containing polyamine. Whether or not this is the case, the azetidinium-containing polyamine can have a ratio of crosslinked or uncrosslinked azetidinium groups to other amine groups of from 0.1:1 to 10:1, from 0.1:1 to 5:1, or from 1:1 to 10:1. In other examples, the azetidinium-containing polyamine can have a ratio of crosslinked or uncrosslinked azetidinium groups to other amine groups of from 0.5:1 to 2:1. Non-limiting examples of commercially available azetidinium-containing polyamines that fall within these ranges of azetidinium group to amine groups include Crepetrol™ 73, Kymene™ 736, Polycup™ 1884, Polycup™ 7360, and Polycup™ 7360A, which are available from Solenis LLC (Delaware, USA). Other compounds from this or other companies can likewise be used.

With more specific detail regarding the Polycup™ family of azetidinium-containing polyamines, these resins tend to be formaldehyde-free, water-based crosslinking resins that are reactive with amine groups, carboxyl groups, hydroxyl groups, and thiol groups. Many of these types of groups can be present at the surface of fabric substrates, so in addition to crosslinking that may occur with the polyurethanes that are present in the ink compositions, there can be additional crosslinking at the surface of the print media substrate, particularly with respect to many different types of synthetic and/or natural fabrics. The azetidinium-containing polyamines, such as these Polycup™ brand resins, in conjunction with the second quaternary amine-containing polymer that is also present in the fixer fluid composition, can promote water resistance to the printed images on the fabric. As one specific example, Polycup™ 7360 is a thermosetting polyamine epichlorohydrin that can include the polymer in a fluid carrier at about 38 wt % solids, and can have a range of viscosities from about 180 cP to about 300 cP at 25° C., for example. The pH of the dispersion as provided can be from about pH 2.5 to about pH 4. Curing can be modulated by modification of concentration, time, temperature, pH, etc. For example, by bringing the pH of a polyamine epichlorohydrin up to about pH 7 to about pH 9 (by fixer fluid composition formulation, by mixing with ink on the fabric substrate, by the pH of the fabric substrate, etc.), curing at temperatures from about 80° C. to about 150° C. can be effective. With this and other examples, curing can be carried out using convection heating, air-draft ovens, radiant heat, infrared heating, etc. Furthermore, with these types of materials, natural crosslinking can continue to occur, if crosslinking groups are still available, at ambient temperatures over a period of weeks, e.g., 1 to 6 weeks, with some polymers.

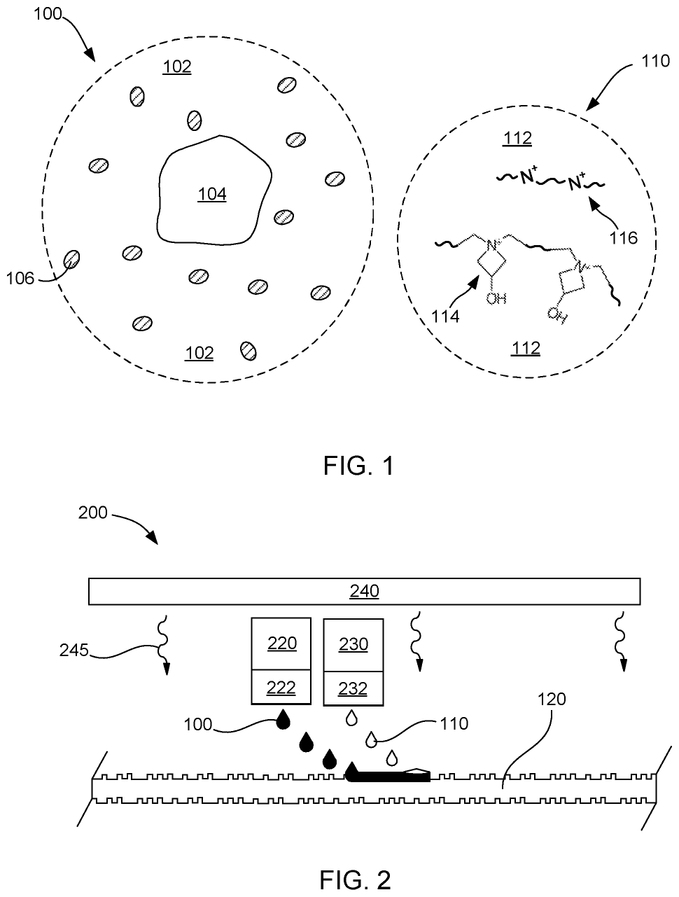

Thus, when the fixer fluid composition is printed on the print media substrate, such as a fabric substrate (not shown in FIG. 1, but shown in FIG. 2), suitable reactive groups that may be present at a surface of the polyurethane binder in the ink composition, and in some instances, hydroxyl groups (e.g. for cotton), amine groups (e.g. for nylon), thiol groups (e.g. for wool), or other suitable reactive groups that may be present at the surface of the print media substrate, can interact with the azetidinium groups in the fixer fluid composition to generate a high quality image that exhibits durable washfastness as demonstrated in the examples hereinafter. The cationic polymer including an azetidinium-containing polyamine can be present in the fixer fluid composition at from 0.5 wt % to 12 wt %, from 1 wt % to 7 wt %, from 2 wt % to 6 wt %, from 3 wt % to 5 wt %, or from 3 wt % to 6 wt %, for example.

Non-limiting but illustrative example reactions between the azetidinium group and various reactive groups are illustrated below in Formulas as follows:

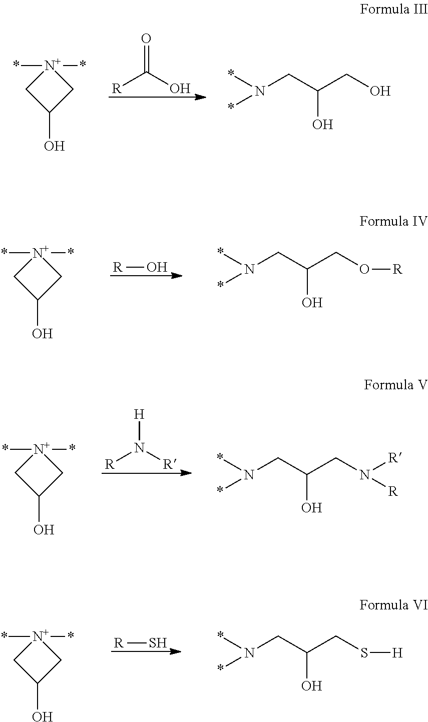

As with Formulas I and II, in Formulas the asterisks (*) represent portions of the various organic compounds or polymer that may not be directly part of the reaction shown in Formulas I-VI, and are thus not shown, but could be any of a number of organic groups, polymeric portions, functional moieties, etc., for example. Likewise, R and R′ can be H or any of a number of organic groups, such as those described previously in connection with R₁ or R₂ in Formula II, without limitation.

In further detail, in accordance with examples of the present disclosure, the azetidinium groups present in the fixer fluid composition can interact with the polyurethane binder, the print media substrate, or both to form a covalent linkage therewith, as shown in Formulas III-VI above. Other types of reactions can also occur, but Formulas III-VI are provided by way of example to illustrate examples of reactions that can occur when the ink composition, the print media substrate, or both come into contact with the fixer fluid composition, e.g., interaction or reaction with the substrate, interaction or reaction between different types of polyurethane polymer, interaction or reaction between different types of azetidinium-containing polyamines, interactions or reactions with different molar ratios (other than 1:1, for example) than that shown in Formulas etc.

Also shown in FIG. 1 is the second quaternary amine-containing polymer 116. This cationic polymer is referred to as a “second” quaternary amine-containing cationic polymer because the azetidinium-containing polyamine 114 previously described is also a quaternary-amine-containing cationic polymer. Thus, in addition to the azetidinium-containing polyamine, the second quaternary amine-containing polymer is also included in the fixer fluid composition 110. Example quaternary amine-containing polymers that can be used in addition to the azetidinium-containing polyamine can include, for example, epichlorohydrin amine polymers, alkoxylated quaternary polyamines, polydiallyldimethylammonium polymers, quaternized ionene-containing polymers, N,N-dimethylaminoethyl methacrylate quaternary polymers, etc., or a combination thereof. The quaternary amine-containing polymers can be included with any anionic counterion suitable for such polymers including halides, e.g., chloride, bromide, iodide, etc., or any other similarly charged anion. The counterion used for the azetidinium-containing polyamine and the second quaternary amine-containing polymer can be the same in many instances, or can be the same when combined, or there can be a variety of counterions associated with the various cationic polymers.

In one example, the quaternary amine-containing polymer can include a quaternary epichlorohydrin amine polymer, e.g., dimethylamine-epichlorohydrin copolymer. Other similar quaternary amine-containing polymers can be used as well, including other alkoxylated quaternary polyamines. For example, the quaternary amine-containing polymer can include a dimethylamine-epichlorohydrin copolymer having the structure of Formula VII. Likewise, the quaternary amine-containing polymer can be defined more generally as shown in Formula VIII.

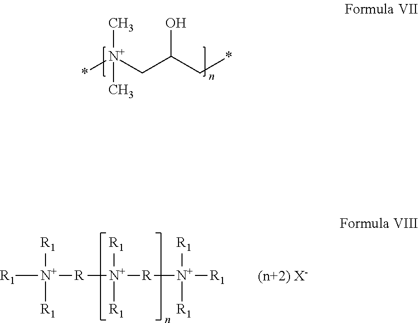

where n is from 5 to 1,500, or can be from 10 to 500, from 20 to 400, from 20 to 250, or from 25 to 200; and X can be any suitable counter ion, such as a halogen, e.g., chloride, bromide, iodide, etc., or other similarly charged anion (for both examples, namely Formula VII and Formula VIII). Formula VII above is representative of Floquat® FL-2350, available from SNF (UK) Ltd., United Kingdom. Formula VIII above is representative of a more general formula of a quaternary polyamine (that may also be alkoxylated or dialkyoxylated at one or multiple R groups) where R can be linear or branched C₂-C₁₂ alkyl, C₃-C₁₂ hydroxyalkyl (which includes dihydroxyalkyl), C₅-C₁₂ aryl, C₅-C₁₂ alicyclic, C₅-C₁₆ alkyl aryl, or C₅-C₁₆ alkyl alicyclic; R₁ can be linear or branched C₁-C₄ alkyl, C₁-C₄ hydroxyalkyl (which includes dihydroxyalkyl), C₅-C₁₂ aryl, C₅-C₁₂ alicyclic, C₅-C₁₆ alkyl aryl, or C₅-C₁₆ alkyl alicyclic. In a typical example, R may be alkoxylated and R₁ may be alkyl, aryl, or alkylaryl.

In another example, the quaternary amine-containing polymer can include a polydiallyldimethylammonium, e.g., polyDADMAC quaternary salt such as a chloride salt, as shown by example in Formula IX, as follows:

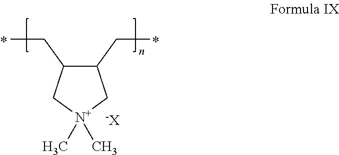

where n is from 5 to 1,500, or can be from 10 to 500, from 20 to 400, from 20 to 250, or from 25 to 200; and X can be any suitable counter ion, such as a halogen, e.g., chloride, bromide, iodide, etc., or other similarly charged anion.

In another example, the quaternary amine-containing polymer can be an ionene polymer, which is a polymer having ionic groups that are appended to the backbone unit as a side-chain, with an example including a quaternized poly(4-vinyl pyridine), having a general structure as shown in Formula X, as follows:

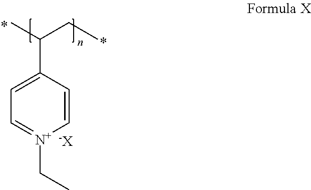

In this example, X can be any suitable counter ion, such as a halogen, e.g., chloride, bromide, iodide, etc., or other similarly charged anion; and n can be from 5 to 1,500, or can be from 10 to 500, from 20 to 400, from 20 to 250, or from 25 to 200, for example.

The second quaternary amine-containing polymers, including the quaternary amine-containing polymers described herein and shown in formulas VII-X as well as others, can have a weight average molecular weight of from 1,000 Mw to 250,000 Mw, from 2,000 Mw to 200,000 Mw, from 2,000 Mw to 100,000 Mw, from 2,000 Mw to 75,000 Mw, from 2,000 Mw to 50,000 Mw, from 5,000 Mw 50,000 Mw, from 5,000 Mw to 30,000 Mw, or from 5,000 Mw to 20,000 Mw, for example.

As shown in FIG. 2, a textile printing system 200 is shown schematically and can include an ink composition 100 and a fixer fluid composition 110 for printing on a textile substrate 120. In some examples, the textile printing system can further include various architectures related to ejecting fluids and treating fluids after ejecting onto the print media substrate. For example, the ink composition can be printed from an inkjet pen 220 which includes an ejector 222, such as a thermal inkjet ejector or some other digital ejector technology. Likewise, the fixer fluid composition can be printed from a fluidjet pen 230 which includes an ejector 232, such as a thermal ejector or some other digital ejector technology. The inkjet pen and the fluidjet pen can be the same type of ejector or can be two different types of ejectors. Both may be thermal inkjet ejectors, for example. Also shown, as can be included in one example, is a heating device 240 to apply heat 245 to the print media substrate to cure the ink composition, e.g., causing the crosslinking reaction to occur or accelerate.

Though a fabric print medium is shown in FIG. 2, the ink compositions 100 and fixer fluid compositions 110 may be suitable for printing on many types of print media substrates 120, such as papers, films, etc. If printing on fabric, for example, example natural fiber fabrics that can be used include treated or untreated natural fabric textile substrates, e.g., wool, cotton, silk, linen, jute, flax, hemp, rayon fibers, thermoplastic aliphatic polymeric fibers derived from renewable resources (e.g. cornstarch, tapioca products, sugarcanes), etc. Example synthetic fibers used in the fabric substrates can include polymeric fibers such as, nylon fibers, polyvinyl chloride (PVC) fibers, PVC-free fibers made of polyester, polyamide, polyimide, polyacrylic, polypropylene, polyethylene, polyurethane, polystyrene, polyaramid (e.g., Kevlar®) polytetrafluoroethylene (Teflon®) (both trademarks of E. I. du Pont de Nemours Company, Delaware), fiberglass, polytrimethylene, polycarbonate, polyethylene terephthalate, polyester terephthalate, polybutylene terephthalate, or a combination thereof. In some examples, the fiber can be a modified fiber from the above-listed polymers. The term “modified fiber” refers to one or both of the polymeric fiber and the fabric as a whole having undergone a chemical or physical process such as, but not limited to, a copolymerization with monomers of other polymers, a chemical grafting reaction to contact a chemical functional group with one or both the polymeric fiber and a surface of the fabric, a plasma treatment, a solvent treatment, acid etching, or a biological treatment, an enzyme treatment, or antimicrobial treatment to prevent biological degradation.

The fabric substrate can be in one of many different forms, including, for example, a textile, a cloth, a fabric material, fabric clothing, or other fabric product suitable for applying ink, and the fabric substrate can have any of a number of fabric structures. The term “fabric structure” is intended to include structures that can have warp and weft, and/or can be woven, non-woven, knitted, tufted, crocheted, knotted, and pressured, for example. The terms “warp” and “weft” have their ordinary meaning in the textile arts, as used herein, e.g., warp refers to lengthwise or longitudinal yarns on a loom, while weft refers to crosswise or transverse yarns on a loom.

It is notable that the term “fabric substrate” or “fabric media substrate” does not include materials considered to be paper (even though paper can include multiple types of natural and synthetic fibers or mixtures of both types of fibers). Fabric substrates can include textiles in filament form, textiles in the form of fabric material, or textiles in the form of fabric that has been crafted into a finished article (e.g. clothing, blankets, tablecloths, napkins, towels, bedding material, curtains, carpet, handbags, shoes, banners, signs, flags, etc.). In some examples, the fabric substrate can have a woven, knitted, non-woven, or tufted fabric structure. In one example, the fabric substrate can be a woven fabric where warp yarns and weft yarns can be mutually positioned at an angle of 90°. This woven fabric can include but is not limited to, fabric with a plain weave structure, fabric with twill weave structure where the twill weave produces diagonal lines on a face of the fabric, or a satin weave. In another example, the fabric substrate can be a knitted fabric with a loop structure. The loop structure can be a warp-knit fabric, a weft-knit fabric, or a combination thereof. A warp-knit fabric refers to every loop in a fabric structure that can be formed from a separate yarn mainly introduced in a longitudinal fabric direction. A weft-knit fabric refers to loops of one row of fabric that can be formed from the same yarn. In a further example, the fabric substrate can be a non-woven fabric. For example, the non-woven fabric can be a flexible fabric that can include a plurality of fibers or filaments that are one or both bonded together and interlocked together by a chemical treatment process (e.g., a solvent treatment), a mechanical treatment process (e.g., embossing), a thermal treatment process, or a combination of multiple processes.

As previously mentioned, the fabric substrate can be a combination of fiber types, e.g. a combination of any natural fiber with another natural fiber, any natural fiber with a synthetic fiber, a synthetic fiber with another synthetic fiber, or mixtures of multiple types of natural fibers and/or synthetic fibers in any of the above combinations. In some examples, the fabric substrate can include natural fiber and synthetic fiber. The amount of the various types of fiber type can vary. For example, the amount of the natural fiber can vary from 5 wt % to 95 wt % and the amount of synthetic fiber can range from 5 wt % to 95 wt %. In yet another example, the amount of the natural fiber can vary from 10 wt % to 80 wt % and the synthetic fiber can be present from 20 wt % to 90 wt %. In other examples, the amount of the natural fiber can be 10 wt % to 90 wt % and the amount of synthetic fiber can also be 10 wt % to 90 wt %. Likewise, the ratio of natural fiber to synthetic fiber in the fabric substrate can vary. For example, the ratio of natural fiber to synthetic fiber can be 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, or vice versa.

In one example, the fabric substrate can have a basis weight ranging from 10 gsm to 500 gsm. In another example, the fabric substrate can have a basis weight ranging from 50 gsm to 400 gsm. In other examples, the fabric substrate can have a basis weight ranging from 100 gsm to 300 gsm, from 75 gsm to 250 gsm, from 125 gsm to 300 gsm, or from 150 gsm to 350 gsm.

In addition, the fabric substrate can contain additives including, but not limited to, colorant (e.g., pigments, dyes, and tints), antistatic agents, brightening agents, nucleating agents, antioxidants, UV stabilizers, fillers and lubricants, for example. Alternatively, the fabric substrate may be pre-treated in a solution containing the substances listed above before applying other treatments or coating layers.

Regardless of the substrate, whether paper, natural fabric, synthetic fabric, fabric blend, treated, untreated, etc., the print media substrates printed with the fluid sets of the present disclosure can provide acceptable optical density (OD) and/or washfastness properties. The term “washfastness” can be defined as the OD that is retained or delta E (ΔE) after five (5) standard washing machine cycles using warm water and a standard clothing detergent (e.g., Tide® available from Proctor and Gamble, Cincinnati, Ohio, USA). Essentially, by measuring OD and/or L*a*b* both before and after washing, ΔOD and ΔE value can be determined, which is essentially a quantitative way of expressing the difference between the OD and/or L*a*b* prior to and after undergoing the washing cycles. Thus, the lower the ΔOD and ΔE values, the better. In further detail, ΔE is a single number that represents the “distance” between two colors, which in accordance with the present disclosure, is the color (or black) prior to washing and the modified color (or modified black) after washing.

Colors, for example, can be expressed as CIELAB values. It is noted that color differences may not be symmetrical going in both directions (pre-washing to post washing vs. post-washing to pre-washing). Using the CIE 1976 definition, the color difference can be measured and the ΔE value calculated based on subtracting the pre-washing color values of L*, a*, and b* from the post-washing color values of L*, a*, and b*. Those values can then be squared, and then a square root of the sum can be determined to arrive at the ΔE value. The 1976 standard can be referred to herein as “ΔE_{CIE}.” The CIE definition was modified in 1994 to address some perceptual non-uniformities, retaining the L*a*b* color space, but modifying to define the L*a*b* color space with differences in lightness (L*), chroma (C*), and hue (h*) calculated from L*a*b* coordinates. Then in 2000, the CIEDE standard was established to further resolve the perceptual non-uniformities by adding five corrections, namely i) hue rotation (R_{T}) to deal with the problematic blue region at hue angles of 275°), ii) compensation for neutral colors or the primed values in the L*C*h differences, iii) compensation for lightness (S_{L}), iv) compensation for chroma (S_{C}), and v) compensation for hue (S_{H}). The 2000 modification can be referred to herein as “ΔE₂₀₀₀.” In accordance with examples of the present disclosure, ΔE value can be determined using the CIE definition established in 1976, 1994, and 2000 to demonstrate washfastness. However, in the examples of the present disclosure, ΔE_{CIE} and ΔE₂₀₀₀ are used. Further, in 1984, a difference measurement, based on an L*C*h model was defined and called CMC I:c. This metric has two parameters: lightness (l) and chroma (c), allowing users to weigh the difference based on the ratio of l:c that is deemed appropriate for the application. Commonly used values include 2:1 for acceptability and 1:1 for threshold of imperceptibility. This difference metric is also reported in various examples of the present disclosure.

In further detail, the textile printing system 200 can include a fixer fluid composition 110, which can include a fixing agent including an azetidinium-containing polyamine and a second quaternary amine-containing polymer in a liquid vehicle, as previously mentioned. The fixer fluid composition can be printed from a fluidjet pen 230 which includes an ejector 232, such as a fluid ejector which can also be a thermal inkjet ejector. As mentioned, in one example, the azetidinium groups of the fixer fluid composition can interact with the polyurethane binder (of the ink composition 100), the print media substrate 120, or both to form a covalent linkage therewith. In some examples, a curing device 240 can be used to apply heat to the print media substrate to cure the ink composition, e.g., causing the crosslinking reaction to occur or accelerate. Heat can be applied using forced hot air, a heating lamp, an oven, or the like. Curing the ink composition contacted with the fixer fluid composition on the print media substrate can occur at a temperature from 80° C. to 200° C. for from 5 seconds to 10 minutes, or from 120° C. to 180° C. for from 30 seconds to 5 minutes.

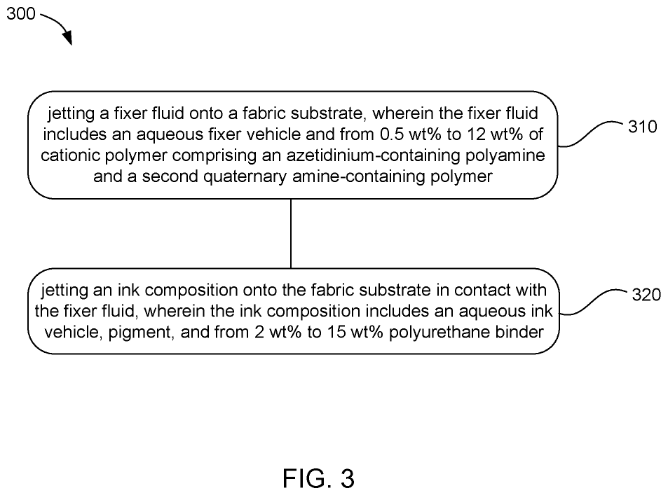

In another example, and as set forth in FIG. 3, a method 300 of printing can include jetting 310 a fixer fluid composition onto a fabric substrate, wherein the fixer fluid composition includes an aqueous fixer vehicle and from 0.5 wt % to 12 wt % of cationic polymer comprising an azetidinium-containing polyamine and a second quaternary amine-containing polymer. The method can also include jetting an ink composition onto the fabric substrate in contact with the fixer fluid composition, wherein the ink composition includes an aqueous ink vehicle, pigment, and from 2 wt % to 15 wt % polyurethane binder.

In some specific examples, jetting the fixer fluid composition onto the print media substrate and jetting the ink composition onto the print media substrate can be performed simultaneously. In other examples, jetting the fixer fluid composition onto the print media substrate can be performed prior to jetting the ink composition onto the print media substrate. For example, the fixer fluid composition can be applied to any digital jetting method (e.g. piezo, thermal, mechanical jetting, etc.) and to the print media substrate followed by jetting the ink composition onto the print media substrate. In some examples, the cationic polymer (which includes both types of cationic polymer) and the polyurethane binder can be jetted onto the print media substrate at a weight ratio of from 0.05:1 to 2:1, or from 0.2:1 to 1:1. In other examples, the cationic polymer and the polyurethane binder can be jetted onto the print media substrate at a weight ratio from 0.2:1 to 1:1. In these examples, the cationic polymer is based on a total content of the azetidinium-containing polyamine and a second quaternary amine-containing polymer.

For purposes of good jettability, the fixer fluid composition can typically have a surface tension of from 21 dyne/cm to 55 dyne/cm at 25° C. and a viscosity of from 1.5 cP to 15 cP at 25° C., which is particularly useful for thermal ejector technology, though surface tensions outside of this range can be used for some types of ejector technology, e.g., piezoelectric ejector technology. Surface tension can be measured by the Wilhelmy plate method with a Kruss tensiometer.

It is also noted that the method of printing can also include heating the fixer fluid composition and the ink composition to a temperature from 80° C. to 200° C. for a period of from 5 seconds to 10 minutes, or from 120° C. to 180° C. for a period of 30 seconds to 5 minutes, or other suitable temperature and time-frame as disclosed herein. Suitable heating devices can include heating lamps, curing ovens, forced air drying devices, or the like that apply heated air to the media substrate.

It is noted that, as used in this specification and the appended claims, the singular forms “a,” “an,” and “the” include plural referents unless the content clearly dictates otherwise.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those in the field technology to determine based on experience and the associated description herein.

As used herein, a plurality of items, structural elements, compositional elements, and/or materials may be presented in a common list for convenience. However, these lists should be construed as though individual members of the list are individually identified as a separate and unique member. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include the numerical values explicitly recited as the limits of the range, but also all the individual numerical values or sub-ranges encompassed within that range as if individual numerical values and sub-ranges are explicitly recited. For example, a weight ratio range of about 1 wt % to about 20 wt % should be interpreted to include the explicitly recited limits of about 1 wt % and about 20 wt %, but also to include individual weights such as 2 wt %, 11 wt %, 14 wt %, and sub-ranges such as 10 wt % to 20 wt %, 5 wt % to 15 wt %, etc.

### EXAMPLES

The following examples illustrate the technology of the present disclosure. However, it is to be understood that the following are illustrative of the application of the principles of the presented fabric print media and associated methods. Numerous modifications and alternatives may be devised without departing from the present disclosure. The appended claims are intended to cover such modifications and arrangements. Thus, while the disclosure has been provided with particularity, the following describes further detail in connection with what are presently deemed to be the acceptable examples.

### Example 1—Preparation of Ink Compositions

Various ink compositions were prepared in accordance with the general formulations shown in Tables 1. Specifically, a Black (K) Ink, a Cyan (C) Ink, a Magenta (M) Ink, and a Yellow (Y) Ink were prepared with Impranil® DLN-SD polyurethane binder, as shown in Table 1.

TABLE 1
K, C, M, Y Ink Compositions with Polyurethane Binder

| | | Black | Cyan | Magenta | Yellow |
|---|---|---|---|---|---|
| Ink ID | Category | Ink (K) | Ink (C) | Ink (M) | Ink (Y) |
| Black Pigment | Pigment Dispersion | 2.5 wt % | — | — | — |
| Cyan Pigment | Pigment Dispersion | — | 2.5 wt % | — | — |
| Magenta Pigment | Pigment Dispersion | — | — | 3.0 wt % | — |
| Yellow Pigment | Pigment Dispersion | — | — | — | 3.0 wt % |
| Impranil ® DLN-SD | Polyurethane Binder | 6 wt % | 6 wt % | 6 wt % | 6 wt % |
| Glycerol | Organic Co-solvent | 8 wt % | 8 wt % | 8 wt % | 8 wt % |
| Crodafos ™ N3A | Surfactant | 0.5 wt % | 0.5 wt % | 0.5 wt % | 0.5 wt % |
| LEG-1 | Organic Co-solvent | 1 wt % | 1 wt % | 1 wt % | 1 wt % |
| Surfynol ® 440 | Surfactant | 0.3 wt % | 0.3 wt % | 0.3 wt % | 0.3 wt % |
| Acticide ® B20 | Biocide | 0.044 wt % | 0.044 wt % | 0.044 wt % | 0.044 wt % |
| Deionized Water | Solvent | Balance | Balance | Balance | Balance |

Impranil ® is available from Covestro (USA).
Crodafos ™ is available from Croda ® International Plc. (Great Britain).
Surfynol ® is available from Evonik, (Germany).
Acticide ® is available from Thor Specialties, Inc. (USA).
Weight % is based on Solids Content where applicable, e.g., pigment, binder, etc.

### Example 2—Preparation of Fixer Fluid Compositions

Three fixer fluid compositions with cationic polymer including an azetidinium-containing polyamine was prepared. Two of the samples also included a second quaternary amine-containing polymer. The Fixer formulations are identified in Table 2, as follows:

TABLE 2
Fixer Compositions

| | | Fixer 1 | | |
|---|---|---|---|---|
| Component | Category | (Control) | Fixer 2 | Fixer 3 |
| 2-Pyrrolidone | Organic Co-solvent | 12 wt % | 12 wt % | 12 wt % |
| Polycup ™ | Azetidinium- | 3 wt % | 3 wt % | 3 wt % |
| 7360A | containing polyamine | | | |
| Floquat ™ | Quaternary amine- | — | 3 wt % | — |
| FL-2350 | containing polymer | | | |
| (25,000 Mw) | | | | |
| PolyDADMAC | Quaternary amine- | — | — | 3 wt % |
| (8,500 Mw) | containing polymer | | | |
| Surfynol ® 440 | Surfactant | 0.3 wt % | 0.3 wt % | 0.3 wt % |
| Water | Solvent | Balance | Balance | Balance |

Fixer Composition Properties

| | | | |
|---|---|---|---|
| pH at 25° C. | pH 4.01 | pH 4.54 | pH 3.2 |
| Viscosity at 25° C. | 2.7 cP | 3.2 cP | 3.5 cP |
| Accelerated Shelf Life Viscosity | 2.5 cP | 3.5 cP | 3.2 cP |
| (at 25° C. after 1 week | | | |
| storage at 60° C.) | | | |

Polycup ™ is available from Solenis LLC (Delaware).
Floquat ™ is available from SNF Ltd. (United Kingdom).
Poly(DADMAC) is poly(diallyldimethylammonium chloride).
Surfynol ® is available from Evonik, (Germany).
Weight % is based on Solids Content where applicable, e.g., polymer.

### Example 3—Washfastness for Inks with Polyurethane Binder and Quaternary Amine-Containing Polymer Fixer

Inks K, C, M, and Y from Example 1 (20 grams per square meter (gsm, wet) were printed with the fixer fluid compositions from Example 2 (10 gsm, wet) as well as without any fixer fluid composition. The various combinations were jetted onto 100% cotton fabric samples from Texlon Corporation (USA). Printed samples were washed 5 times with Sears Kenmore 90 Series Washer (Model 110.289 227 91) and warm water (about 40° C.) with detergent and air drying between washes. The samples were measured for OD and L*a*b* before and after the 5 washes. After the five cycles, optical density (OD) and L*a*b* values were measured for comparison, and delta E (ΔE) values were calculated using the 1976 standard denoted as ΔE_{CIE} as well as the 2000 standard denoted as ΔE₂₀₀₀. ΔE_{CMC} (2:1) values are also reported. The purpose of this study was to investigate whether blending an azetidinium-containing polyamine with a second polyamine would enhance optical density and/or washfastness durability. All data was collected after printing the fixer (if any) at 10 gsm, then printing the ink composition directly on the fixer (if present), and then heat curing at 150° C. for 3 minutes. The results are provided in Table 3, as follows:

TABLE 3
Optical Density and Washfastness Durability on 100% Cotton Substrate

| | | 100% Cotton Substrate | | | | | |
|---|---|---|---|---|---|---|---|
| Fixer ID (1.5 dpp) | Ink ID (3 dpp) | OD (0 wash) | OD (5 washes) | % ΔOD | ΔE_{CIE} | ΔE₂₀₀₀ | ΔE_{CMC} (2:1) |
| None | K | 1.071 | 0.969 | −9.5 | 6.54 | 5.81 | 6.99 |
| (Control) | C | 1.072 | 0.995 | −7.2 | 4.62 | 2.77 | 2.66 |
| | M | 0.996 | 0.905 | −9.1 | 6.40 | 3.05 | 2.84 |
| | Y | 1.038 | 0.864 | −16.8 | 10.29 | 2.26 | 3.22 |
| Fixer 1 | K | 1.155 | 1.134 | −1.9 | 2.82 | 2.73 | 3.71 |
| (Control) | C | 1.151 | 1.105 | -4.0 | 3.83 | 1.72 | 2.08 |
| | M | 1.065 | 1.039 | −2.4 | 3.96 | 1.71 | 1.94 |
| | Y | 1.132 | 1.069 | −5.6 | 3.33 | 0.77 | 1.04 |
| Fixer 2 | K | 1.216 | 1.170 | −3.7 | 3.63 | 3.33 | 4.36 |
| | C | 1.237 | 1.143 | −7.6 | 4.25 | 2.68 | 2.31 |
| | M | 1.148 | 1.128 | −1.7 | 3.48 | 1.49 | 1.71 |
| | Y | 1.218 | 1.160 | −4.8 | 2.86 | 0.71 | 0.89 |
| Fixer 3 | K | 1.215 | 1.218 | 0.2 | 2.11 | 2.08 | 2.90 |
| | C | 1.216 | 1.225 | 0.7 | 3.68 | 1.30 | 1.92 |
| | M | 1.134 | 1.096 | −3.3 | 3.46 | 1.46 | 1.70 |
| | Y | 1.210 | 1.154 | −4.6 | 3.04 | 0.70 | 0.94 |

As can be seen in the data presented in Table 3, initial optical density (OD) was the best when both the azetidinium-containing polyamine and either of the quaternary amine-containing polymers were used together (compare to no fixer or the azetidinium-containing polyamine alone). Furthermore, after 5 washes, the % ΔOD, ΔE_{CIE}, ΔE₂₀₀, and ΔE_{CMC}, except for a few instances, tended to be about as good, or even better, than the two control samples. As the OD was initially higher for Fixer 2 and Fixer 3 than the controls, maintaining about the same ΔOD and/or ΔE after 5 washes is a good result because it can be more difficult to retain color values compared to samples starting with lower color values.

While the present technology has been described with reference to certain examples, various modifications, changes, omissions, and substitutions can be made without departing from the spirit of the disclosure. It is intended, therefore, that the disclosure be limited by the scope of the following claims.

What is claimed is:

1. A fluid set, comprising:
an ink composition including:
an aqueous ink vehicle,
pigment, and
from 2 wt % to 15 wt % polyurethane binder; and
a fixer fluid composition including:
an aqueous fixer vehicle, and
from 0.5 wt % to 12 wt % cationic polymers comprising an azetidinium-containing polyamine polymer and a second quaternary amine-containing polymer.

2. The fluid set of claim 1, wherein the pigment includes a black pigment, a cyan pigment, a magenta pigment, a yellow pigment, or a white pigment.

3. The fluid set of claim 1, wherein the azetidinium-containing polyamine polymer comprises from 2 to 12 carbon atoms between individual amine groups.

4. The fluid set of claim 1, wherein the azetidinium-containing polyamine polymer has a molar ratio of crosslinked or uncrosslinked azetidinium groups to amine groups from 0.1:1 to 10:1.

5. The fluid set of claim 1, wherein the second quaternary amine-containing polymer is a quaternary polydiallyldimethylammonium polymer, a quaternary ionene-containing polymer, a quaternary epichlorohydrin amine polymer, a quaternary alkoxylated quaternary polyamine, a quaternary N,N-dimethylaminoethyl methacrylate, or a combination thereof.

6. The fluid set of claim 1, wherein the azetidinium-containing polyamine polymer to second quaternary amine-containing polymer weight ratio is from 1:9 to 9:1.

7. The fluid set of claim 1, wherein the fixer fluid composition has a pH from 2 to 6.

8. The fluid set of claim 1, wherein the fixer fluid composition has a viscosity from 1.5 cP to 12 cP at 25° C.

9. A textile printing system, comprising:
a fabric substrate;
an ink composition including:
an aqueous ink vehicle,
pigment, and
from 2 wt % to 15 wt % polyurethane binder; and
a fixer fluid composition including:
an aqueous fixer vehicle, and
from 0.5 wt % to 12 wt % of cationic polymer comprising an azetidinium-containing polyamine and a second quaternary amine-containing polymer.

10. The textile printing system of claim 9, wherein the fabric substrate is selected from cotton, polyester, nylon, silk, or a blend thereof.

11. The textile printing system of claim 9, wherein the azetidinium-containing polyamine polymer has a ratio of crosslinked or uncrosslinked azetidinium groups to amine groups from 0.1:1 to 10:1.

12. A method of printing, comprising:
jetting a fixer fluid composition onto a fabric substrate, wherein the fixer fluid composition includes an aqueous fixer vehicle and from 0.5 wt % to 12 wt % of cationic polymer comprising an azetidinium-containing polyamine and a second quaternary amine-containing polymer; and
jetting an ink composition onto the fabric substrate in contact with the fixer fluid composition, wherein the ink composition includes an aqueous ink vehicle, pigment, and from 2 wt % to 15 wt % polyurethane binder.

13. The method of claim 12, wherein the cationic polymer and the polyurethane are jetted onto the fabric substrate in contact at a weight ratio from 0.01:1 to 1:1, wherein the cationic polymer is based on a total content of the azetidinium-containing polyamine and a second quaternary amine-containing polymer.

14. The method of claim 12, further comprising heating the fabric substrate having the fixer fluid composition and the ink composition jetted thereon to a temperature from 80° C. to 200° C. for a period from 5 seconds to 10 minutes.

15. The method of claim 12, wherein the azetidinium-containing polyamine has a ratio of crosslinked or uncrosslinked azetidinium groups to amine groups from 0.1:1 to 10:1.
